(19) United States
(12) Patent Application Publication
(10) Pub. No.: US 2013/0141686 A1
(43) Pub. Date: Jun. 6, 2013

(54) TAPE SUBSTRATE WITH CHIP ON FILM STRUCTURE FOR LIQUID CRYSTAL DISPLAY PANEL

(71) Applicants: Poshen Lin, Guangdong (CN); Liangchan Liao, Guangdong (CN); Yong Zhang, Guangdong (CN)

(72) Inventors: Poshen Lin, Guangdong (CN); Liangchan Liao, Guangdong (CN); Yong Zhang, Guangdong (CN)

(73) Assignee: SHENZHEN CHINA STAR OPTOELECTRONICS TECHNOLOGY CO., LTD., Shenzhen (CN)

(21) Appl. No.: 13/379,860

(22) PCT Filed: Dec. 2, 2011
(86) PCT No.: PCT/CN11/83362

§ 371 Date: Dec. 21, 2011

(30) Foreign Application Priority Data
Dec. 1, 2011 (CN) 201110392478.X

(51) Int. Cl. G02F 1/1345

(52) U.S. Cl. 349/149; 349/158

(57) ABSTRACT

The present invention provides a tape substrate with chip on film (COF) structures for a liquid crystal display (LCD) panel. A plurality of package units with the COF structures are arranged along a longitudinal direction of the tape substrate. In each of the package units, input leads of the package unit are connected to a second side thereof, and the output leads extend from the second side to the package units in a bending manner. The present invention further provides the liquid crystal display panel using the tape substrate.

### FIELD OF THE INVENTION

The present invention relates to a field of a liquid crystal display (LCD) technology, and more particularly to a tape substrate with chip on film (COF) structures for an LCD panel.

### BACKGROUND OF THE INVENTION

In accordance with the development of liquid crystal display (LCD) technology, a requirement for elements of an LCD panel is higher and higher.

At present, in a COF type package structure, a driving chip is basically packaged with hot press by using a tape automated bonding (TAB) technology. The COF type package structure is coiled for transporting. When using the COF type package structure, COF structures can be obtained by cutting a tape substrate, and are electrically connected between a circuit on a glass substrate of an LCD panel and a driving circuit board. At least one COF structure is disposed between the glass substrate and the driving circuit board. The larger a size of the LCD panel is, the more an amount of the required COF structures is.

However, in the conventional technology, the following problems are likely to arise. Since the width of the tape substrate is limited, and an amount of output leads is increasing gradually, the wiring of the output leads is more and more complicated, and the distance between each two adjacent leads is shorter and shorter. This causes an abnormal signal transmission, thereby deteriorating an image display quality of the LCD panel.

### SUMMARY OF THE INVENTION

An object of the present invention is to provide a tape substrate with COF structures for a liquid crystal display panel, so as to solve the conventional problems wherein, since the width of the tape substrate is limited, and an amount of output leads is increasing gradually, the wiring of the output leads is more and more complicated, and the distance between each two adjacent leads is shorter and shorter, resulting an abnormal signal transmission, and deteriorating an image display quality of the LCD panel.

For solving the above-mentioned problems, the present invention provides a tape substrate with COF structures for an LCD panel. The tape substrate comprises: a substrate body; and a plurality of package units with the COF structures disposed on the substrate body and arranged along a longitudinal direction of the tape substrate, wherein each of the package units comprises input leads, output leads, a first side and a second side, and the first side and the second side are positioned at both sides of the tape substrate and along the longitudinal direction thereof; and wherein, in each of the package units, the output leads are connected to the second side, and the output leads extend from the second side to the package units and have a bonding structure, and the input leads are connected to the first side or the second side.

In the tape substrate with COF structures for the LCD panel of the present invention, the bonding structure has a first bending angle, and the first bending angle is 90 degrees.

In the tape substrate with COF structures for the LCD panel of the present invention, the input leads are connected to the first side.

In the tape substrate with COF structures for the LCD panel of the present invention, the input leads are connected to the second side.

In the tape substrate with COF structures for the LCD panel of the present invention, the input leads extend from the first side or the second side to the package units and have another bonding structure, and the another bonding structure has a second bending angle, and the second bending angle is 90 degrees.

Another object of the present invention is to provide a tape substrate with COF structures for a liquid crystal display panel, so as to solve the conventional problems wherein, since the width of the tape substrate is limited, and an amount of output leads is increasing gradually, the wiring of the output leads is more and more complicated, and the distance between each two adjacent leads is shorter and shorter, resulting an abnormal signal transmission, and deteriorating an image display quality of the LCD panel.

For solving the above-mentioned problems, the present invention provides a tape substrate with COF structures for an LCD panel. The tape substrate with COF structures for an LCD panel comprises: a substrate body; and a plurality of package units with the COF structures disposed on the substrate body and arranged along a longitudinal direction of the tape substrate, wherein each of the package units comprises a driving chip, input leads, output leads, a first side and a second side, and the first side and the second side are positioned at both sides of the tape substrate and along the longitudinal direction thereof, and a longitudinal direction of the driving chip is vertical to the longitudinal direction of the tape substrate; and wherein, in each of the package units, the output leads are connected to the second side, and the output leads extend from the second side to the package units in a bonding manner.

In the tape substrate with COF structures for the LCD panel of the present invention, the output leads have a bonding structure, and the bonding structure has a first bending angle, and the first bending angle is 90 degrees.

In the tape substrate with COF structures for the LCD panel of the present invention, the input leads are connected to the first side.

In the tape substrate with COF structures for the LCD panel of the present invention, the input leads extend from the first side to the package units and have another bonding structure, and the another bonding structure has a second bending angle, and the second bending angle is 90 degrees.

In the tape substrate with COF structures for the LCD panel of the present invention, the input leads are connected to the second side.

In the tape substrate with COF structures for the LCD panel of the present invention, the input leads extend from the second side to the package units and have another bonding structure, and the another bonding structure has a second bending angle, and the second bending angle is 90 degrees.

Still another object of the present invention is to provide a tape substrate with COF structures for a liquid crystal display panel, so as to solve the conventional problems wherein, since the width of the tape substrate is limited, and an amount of output leads is increasing gradually, the wiring of the output leads is more and more complicated, and the distance between each two adjacent leads is shorter and shorter, resulting an abnormal signal transmission, and deteriorating an image display quality of the LCD panel.

For solving the above-mentioned problems, the present invention provides an LCD panel. The LCD panel comprises: a first substrate; a second substrate; a driving circuit board electrically connected to the second substrate by a plurality of package units with COF structures, wherein each of the package units comprises a driving chip, input leads, output leads, a first side and a second side, and the first side and the second side are positioned at both sides of the tape substrate and along the longitudinal direction thereof, and a longitudinal direction of the driving chip is vertical to the longitudinal direction of the tape substrate; and wherein, in each of the package units, the output leads are connected to the second side, and the output leads extend from the second side to the package units in a bonding manner.

In the LCD panel of the present invention, the output leads have a bonding structure, and the bonding structure has a first bending angle, and the first bending angle is 90 degrees.

In the LCD panel of the present invention, the input leads are connected to the first side.

In the LCD panel of the present invention, the input leads extend from the first side to the package units and have another bonding structure, and the another bonding structure has a second bending angle, and the second bending angle is 90 degrees.

In the LCD panel of the present invention, the input leads are connected to the second side.

In the LCD panel of the present invention, the input leads extend from the second side to the package units and have another bonding structure, and the another bonding structure has a second bending angle, and the second bending angle is 90 degrees.

In comparison with the conventional technology, the output leads of each of the package units of the present invention are connected to the second side, wherein the second side is one side of the tape substrate along the longitudinal direction of the tape substrate body. In that manner, the cut COF structures are no longer required to be limited by the width of the tape substrate, and thus the amount of the COF structures can increase flexibly according to a wiring requirement of a large-size LCD panel. Accordingly, a distance between each two adjacent output leads is ensured, so as to prevent an abnormal signal due to a too small distance between the output leads. Furthermore, the output leads extend from the second side to the package units in a bending manner, and specifically have a bonding structure, so as to make the wiring of output leads simpler.

The structure and the technical means adopted by the present invention to achieve the above and other objects can be best understood by referring to the following detailed description of the preferred embodiments and the accompanying drawings.

### DESCRIPTION OF THE DRAWINGS

FIG. 1 is a structural diagram showing a tape substrate with COF structures for an LCD panel according to a first preferred embodiment of the present invention;

FIG. 2 is a structural diagram showing a tape substrate with COF structures for an LCD panel according to a second preferred embodiment of the present invention;

FIG. 3 is a structural diagram showing a tape substrate with COF structures for an LCD panel according to a third preferred embodiment of the present invention;

FIG. 4 is a structural diagram showing a tape substrate with COF structures for an LCD panel according to a fourth preferred embodiment of the present invention;

FIG. 5 is an assembly top view showing a LCD panel, the COF structures corresponding to FIG. 3 and a driving circuit board according to a preferred embodiment of the present invention; and

FIG. 6 is an assembly side view showing the LCD panel, the COF structures corresponding to FIG. 3 and the driving circuit board according to the preferred embodiment of the present invention.

### DETAILED DESCRIPTION OF THE PREFERRED EMBODIMENTS

The following embodiments are referring to the accompanying drawings for exemplifying specific implementable embodiments of the present invention.

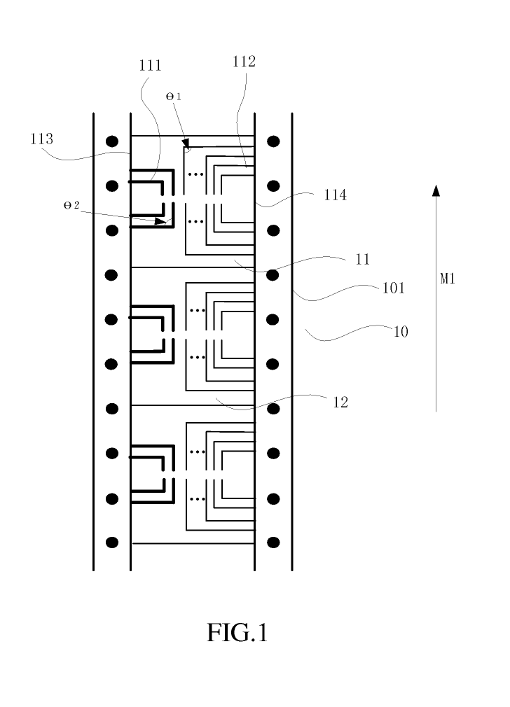

Referring to FIG. 1, FIG. 1 is a structural diagram showing a tape substrate with COF structures for an LCD panel according to a first preferred embodiment of the present invention.

The tape substrate 10 comprises a substrate body 101 and a plurality of package units 11, 12 . . . with the COF structures arranged along a longitudinal direction M1 of the substrate body 10. The package units 11, 12 are disposed on the substrate body 101. Before being cut off, the package units are disposed on the tape substrate 10. In general, the tape substrate 10 can be regarded as a flexible circuit board which comprises at least two flexible polymer layers and a circuit layer (not shown) disposed there between.

Referring to FIG. 1 again, taking the package unit 11 for example, the package unit 11 includes input leads 111 (thicker lines shown in FIG. 1), output leads 112 (thinner lines shown in FIG. 1), a first side 113 and a second side 114, wherein the first side 113 and the second side 114 are positioned at both sides of the tape substrate 10 and along the longitudinal direction M1 thereof. In this embodiment shown in FIG. 1, the input leads 111 are connected to the first side 113, and the output leads 112 are connected to the second side 114. In this case, the input leads 111 and the output leads 112 are a portion of the circuit layer of the tape substrate 10.

Referring to FIG. 1 again, the output leads 112 are connected to the second side 114, and the output leads 112 extend from the second side 114 to the package units 11 in a bending manner. Preferably, the output leads 112 have a bonding structure. Certainly, the output leads 112 can have more bonding structures, which are not enumerated here. By bending the output leads 112, a first bending angle θ1 is formed, and preferably, the first bending angle θ1 is 90 degrees. Certainly, the first bending angle θ1 can be other angles, which are not enumerated here.

Referring to FIG. 1 again, the input leads 111 extend from the first side 113 to the package units 11 in a bending manner. Preferably, the input leads 111 have a bonding structure. Certainly, the input leads 111 can have more bonding structures, which are not enumerated here. By bending the input leads 111, a second bending angle θ2 is formed, and preferably, the second bending angle θ2 is 90 degrees. Certainly, the second bending angle θ2 can be other angles, which are not enumerated here.

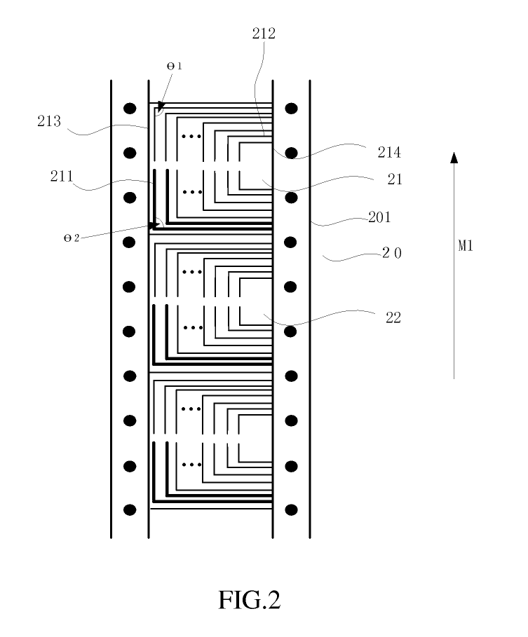

Referring to FIG. 2, FIG. 2 is a structural diagram showing a tape substrate with COF structures for an LCD panel according to a second preferred embodiment of the present invention.

Similar to the first preferred embodiment shown in FIG. 1, the tape substrate 20 shown in FIG. 2 comprises a substrate body 201 and a plurality of package units 21, 22 . . . with the COF structures arranged along a longitudinal direction M1. The package unit 21 includes input leads 211 (thicker lines shown in FIG. 2), output leads 212 (thinner lines shown in FIG. 2), a first side 213 and a second side 214, wherein the first side 213 and the second side 214 are positioned at both sides of the tape substrate 20 and along the longitudinal direction M1 thereof.

Different to the first preferred embodiment shown in FIG. 1, in the embodiment shown in FIG. 2, the input leads 211 (thicker lines shown in FIG. 2) and the output leads 212 (thinner lines shown in FIG. 2) are both connected to the second side 214.

In the embodiment shown in FIG. 2, the input leads 211 and the output leads 212 extend from the second side 214 to the package units 21 in a bending manner. Preferably, the input leads 211 and the output leads 212 have a bonding structure. By bending the output leads 212, a first bending angle θ1 is formed, and preferably, the first bending angle θ1 is 90 degrees. By bending the input leads 211, a second bending angle θ2 is formed, and preferably, the second bending angle θ2 is 90 degrees.

In the embodiments shown in FIG. 1 and FIG. 2, the output leads of each of the package units are connected to the second side, wherein the second side is one side of the tape substrate along the longitudinal direction of the tape substrate body. In that manner, the cut COF structures are not required to be limited by the width of the tape substrate, and thus the amount of the COF structures can increase flexibly according to a wiring requirement of a large-size LCD panel.

Furthermore, the output leads extend from the second side to the package units in a bending manner, and specifically have a bonding structure, so as to make the wiring of output leads simpler.

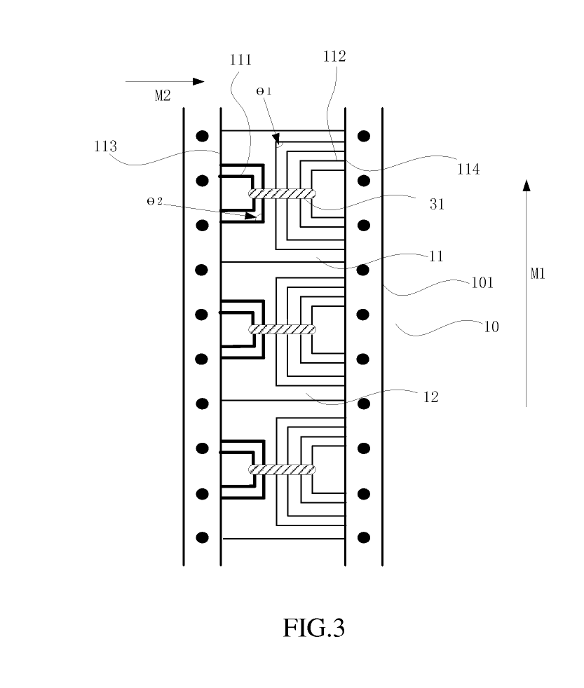

Referring to FIG. 3, FIG. 3 is a structural diagram showing a tape substrate with COF structures for an LCD panel according to a third preferred embodiment of the present invention.

The tape substrate 10 comprises a substrate body 101 and a plurality of package units 11, 12 . . . with the COF structures arranged along a longitudinal direction M1 of the substrate body 10. The package units 11, 12 are disposed on the substrate body 101. Before being cut off, the package units are disposed on the tape substrate 10. In general, the tape substrate 10 can be regarded as a flexible circuit board which comprises at least two flexible polymer layers and a circuit layer (not shown) disposed there between.

Referring to FIG. 3 again, taking the package unit 11 for example, the package unit 11 includes input leads 111 (thicker lines shown in FIG. 3), output leads 112 (thinner lines shown in FIG. 3), a first side 113 and a second side 114, wherein the first side 113 and the second side 114 are positioned at both sides of the tape substrate 10 and along the longitudinal direction M1 thereof. In this embodiment shown in FIG. 3, the input leads 111 are connected to the first side 113, and the output leads 112 are connected to the second side 114. In this case, the input leads 111 and the output leads 112 are a portion of the circuit layer of the tape substrate 10.

Referring to FIG. 3 again, different to the embodiment shown in FIG. 1, in the embodiment shown in FIG. 3, the package unit 11 further comprises a driving chip 31. An active surface of the driving chip 31 faces downwardly, and gold bumps (not shown) of the active surface are bonded to inner ends of the input leads 111 and the output leads 112 with hot press.

In the embodiment shown in FIG. 3, the tape substrate 10 extends along the longitudinal direction M1, and the driving chip 31 extends along a longitudinal direction M2 parallel to the longitudinal direction M1. The package units have been described in FIG. 1, and the similarities are not mentioned here for simplification.

In the embodiments shown in FIG. 3, the input leads and the output leads are each of the package units are connected to the first side and the second side, respectively, wherein the first side and the second side are both sides of the tape substrate along the longitudinal direction thereof. In that manner, the cut COF structures are no longer required to be limited by the width of the tape substrate, and thus the amount of the COF structures can increase flexibly according to a wiring requirement of a large-size LCD panel. Accordingly, a distance between each two adjacent output leads is ensured, so as to prevent an abnormal signal due to a too small distance between the output leads.

Furthermore, the output leads extend from the second side to the package units in a bending manner, and specifically have a bonding structure, so as to make the wiring of output leads simpler.

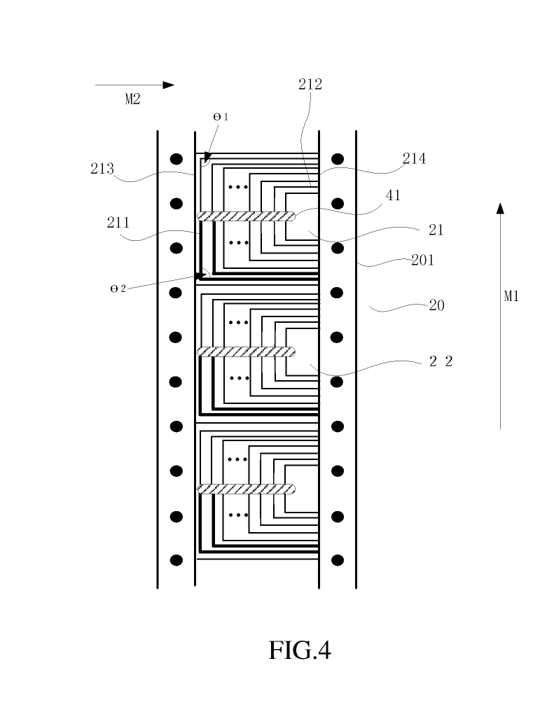

Referring to FIG. 4, FIG. 4 is a structural diagram showing a tape substrate with COF structures for an LCD panel according to a fourth preferred embodiment of the present invention.

In this case, FIG. 4 corresponds to FIG. 2, and a driving chip 41 is added to the structure shown in FIG. 2. Different to the third preferred embodiment shown in FIG. 3, in the embodiment shown in FIG. 4, the input leads 211 (thicker lines shown in FIG. 4) and the output leads 212 (thinner lines shown in FIG. 4) are both connected to the second side 214.

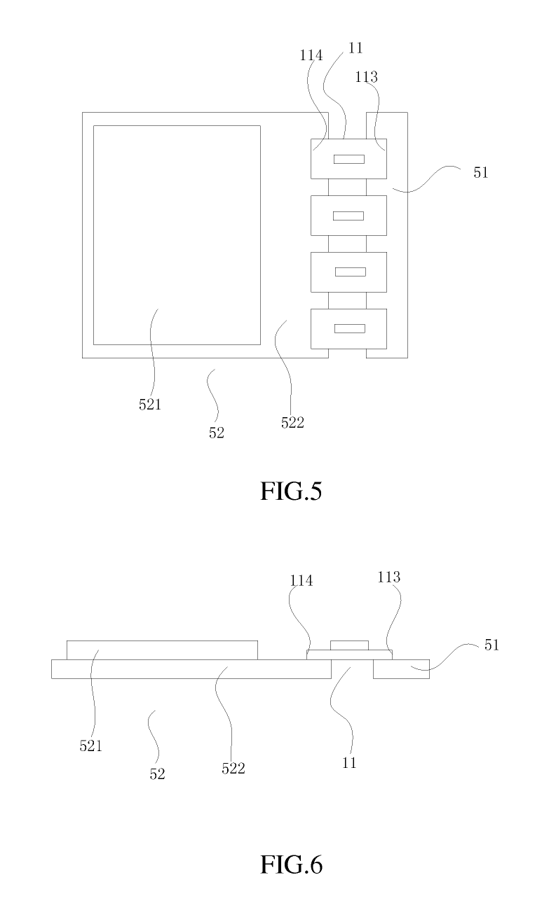

The following embodiments are referring to FIG. 5 and FIG. 6 for exemplifying a LCD panel, the COF structures and a driving circuit board according to the third preferred embodiment shown in FIG. 3, and the fourth preferred embodiment shown in FIG. 4 has the similar principle for referring to each other.

The assembly structure shown in FIG. 5 and FIG. 6 comprises the driving circuit board 51 and the LCD panel 52. The LCD panel 52 comprises a first substrate 521 and a second substrate 522. A transparent circuit on the second substrate 522 is electrically connected to the driving circuit board 51 by the package units with COF structures. In this case, the package units shown in FIG. 5 and FIG. 6 are obtained by cutting the tape substrate shown in FIG. 3 with COF structures for the liquid crystal display panel.

Taking the package unit 11 for example, the package unit 11 is connected to the driving circuit board 51 by the input leads 111, and connected to the second substrate 522 of the LCD panel 52 by the output leads 112.

In this case, referring to FIG. 3 again, the package unit 11 includes the input leads 111 and the output leads 112, the first side 113 and the second side 114, wherein the first side 113 and the second side 114 are positioned at both sides of the tape substrate 10 and along the longitudinal direction M1 thereof. The longitudinal direction M2 of the driving chip 31 is vertical to longitudinal direction M1 of the driving circuit board. The input leads 111 are connected to the first side 113, and the output leads 112 are connected to the second side 114. Moreover, the output leads 112 extend from the second side 114 to the package units 11 in a bending manner. Referring to FIG. 5 and FIG. 6 again, the first side 113 is connected to the driving circuit board 51, so as to allow the input leads 111 to be electrically connected to the driving circuit board 51. The second side 114 is connected to the transparent circuit on the second substrate 522, so as to allow the output leads 112 to be electrically connected to the transparent circuit on the second substrate 522.

The present invention has been described with a preferred embodiment thereof and it is understood that many changes and modifications to the described embodiment can be carried out without departing from the scope and the spirit of the invention that is intended to be limited only by the appended claims.

1. A tape substrate with chip on film (COF) structures for a liquid crystal display panel (LCD), comprising:
a substrate body; and
a plurality of package units with the COF structures disposed on the substrate body and arranged along a longitudinal direction of the tape substrate, wherein each of the package units comprises input leads, output leads, a first side and a second side, and the first side and the second side are positioned at both sides of the tape substrate and along the longitudinal direction thereof;
wherein, in each of the package units, the output leads are connected to the second side, and the output leads extend from the second side to the package units and have a bonding structure, and the input leads are connected to the first side or the second side.

2. The tape substrate with COF structures for the LCD panel according to claim 1, wherein the bonding structure has a first bending angle, and the first bending angle is 90 degrees.

3. The tape substrate with COF structures for the LCD panel according to claim 2, wherein the input leads extend from the first side or the second side to the package units and have another bonding structure, and the another bonding structure has a second bending angle, and the second bending angle is 90 degrees.

4. A tape substrate with COF structures for an LCD panel, comprising:
a substrate body; and
a plurality of package units with the COF structures disposed on the substrate body and arranged along a longitudinal direction of the tape substrate, wherein each of the package units comprises a driving chip, input leads, output leads, a first side and a second side, and the first side and the second side are positioned at both sides of the tape substrate and along the longitudinal direction thereof, and a longitudinal direction of the driving chip is vertical to the longitudinal direction of the tape substrate;
wherein, in each of the package units, the output leads are connected to the second side, and the output leads extend from the second side to the package units in a bonding manner.

5. The tape substrate with COF structures for the LCD panel according to claim 4, wherein the output leads have a bonding structure, and the bonding structure has a first bending angle, and the first bending angle is 90 degrees.

6. The tape substrate with COF structures for the LCD panel according to claim 5, wherein the input leads are connected to the first side.

7. The tape substrate with COF structures for the LCD panel according to claim 6, wherein the input leads extend from the first side to the package units and have another bonding structure, and the another bonding structure has a second bending angle, and the second bending angle is 90 degrees.

8. The tape substrate with COF structures for the LCD panel according to claim 5, the input leads are connected to the second side.

9. The tape substrate with COF structures for the LCD panel according to claim 6, wherein the input leads extend from the second side to the package units and have another bonding structure, and the another bonding structure has a second bending angle, and the second bending angle is 90 degrees.

10. A liquid crystal display (LCD) panel, comprising:
a first substrate;
a second substrate;
a driving circuit board electrically connected to the second substrate by a plurality of package units with COF structures, wherein each of the package units comprises a driving chip, input leads, output leads, a first side and a second side, and the first side and the second side are positioned at both sides of the tape substrate and along the longitudinal direction thereof, and a longitudinal direction of the driving chip is vertical to the longitudinal direction of the tape substrate;
wherein, in each of the package units, the output leads are connected to the second side, and the output leads extend from the second side to the package units in a bonding manner.

11. The LCD panel according to claim 10, wherein the output leads have a bonding structure, and the bonding structure has a first bending angle, and the first bending angle is 90 degrees.

12. The LCD panel according to claim 11, wherein the input leads are connected to the first side.

13. The LCD panel according to claim 12, wherein the input leads extend from the first side to the package units and have another bonding structure, and the another bonding structure has a second bending angle, and the second bending angle is 90 degrees.

14. The LCD panel according to claim 11, wherein the input leads are connected to the second side.

15. The LCD panel according to claim 14, wherein the input leads extend from the second side to the package units and have another bonding structure, and the another bonding structure has a second bending angle, and the second bending angle is 90 degrees.
